(19) United States
(12) Patent Application Publication
(10) Pub. No.: US 2024/0106845 A1
(43) Pub. Date: Mar. 28, 2024

(54) MOBILE EDGE COMPUTING SYSTEM AND METHOD OF CONSTRUCTING TRAFFIC DATA FEATURE SET USING THE SAME

(71) Applicant: SYSMATE CO., LTD., Daejeon (KR)

(72) Inventors: Byungkon SONG, Seoul (KR); Junsung KIM, Daejeon (KR); Yookyoung LEE, Sejong-si (KR); Ganho CHOI, Daejeon (KR)

(73) Assignee: SYSMATE CO., LTD., Daejeon (KR)

(21) Appl. No.: 17/980,500

(22) Filed: Nov. 3, 2022

(30) Foreign Application Priority Data
Sep. 26, 2022 (KR) 10-2022-0121448

(51) Int. Cl. H04L 9/40

(52) U.S. Cl. CPC H04L 63/1425; H04L 63/1416; H04L 63/166

(57) ABSTRACT

Disclosed are a mobile edge computing system and a method of constructing a data feature set using the same. A mobile network system in a mobile edge computing (MEC) environment according to an embodiment includes a switch configured to copy a front end of an input packet, an MEC device configured to receive a front end copied packet from the switch to extract a data feature set of mobile network traffic, and a host configured to receive the traffic data feature set extracted from the MEC device to perform a security service.

### CROSS-REFERENCE TO RELATED APPLICATION(S)

This application claims priority from Korean Patent Application No. 10-2022-0121448, filed on Sep. 26, 2022, in the Korean Intellectual Property Office, the disclosure of which is incorporated herein by reference in its entirety.

### BACKGROUND

### 1. Field

The present disclosure relates to packet processing technology.

### 2. DESCRIPTION OF RELATED ART

When a user packet is transmitted to a local server in a mobile network, concepts of mobile edge computing (MEC, hereinafter referred to as “MEC”) and local breakout (LBO, hereinafter referred to as “LBO”) have been introduced and applied in order to realize a low delay and process packets at a high-speed.

The MEC of the mobile network is a cloud edge network switching and computing technology that requires effective realization of high-speed and low-delay real-time data transmission for smart factories, smart cars, real-time Internet of Things (IoT) services, etc. Functions of the MEC and LBO are very useful for a low delay and high-performance packet processing required by new services.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an embodiment, a mobile edge computing system capable of extracting a traffic data feature set in hardware in real-time and a data feature set construction method using the same are proposed.

A mobile network system in a mobile edge computing (MEC) environment according to an embodiment includes a switch configured to copy a front end of an input packet, an MEC device configured to receive a front end copied packet from the switch to extract a data feature set of mobile network traffic, and a host configured to receive a traffic data feature set extracted from the MEC device to perform a security service.

The switch may be configured to copy the front end of the input packet with a predetermined size and to copy the front end by as much as a size of the packet when the size of the input packet is smaller than the predetermined size, and the predetermined size may be set by a user operation or set to a default value.

The MEC device may be a hardware module based on a field programmable gate array (FPGA).

The MEC device may include a packet receiving unit configured to receive the front end copied packet from the switch, a hash value calculating unit configured to calculate a hash value for the copied packet received through the packet receiving unit, and the hash value may be used as an identifier for recognizing a connection or flow of the packet.

The MEC device may include a metadata extracting and packet counting unit configured to generate the traffic data feature set by extracting metadata from the copied packet and calculating a count for each packet type, and a connection data counting unit configured to generate a data feature set for a transmission control protocol (TCP) connection by counting the number of connections.

When the connection is abnormally terminated, the connection data counting unit may determine the termination of the connection by setting a timeout time and may extract statistical data of the abnormal connection, and the timeout time may be set by a user operation or set to a default value.

The MEC device may include a packet reconstruction unit configured to reconstruct the extracted traffic data feature set in the form of an Internet protocol (IP) packet and then transmit the reconstructed traffic data feature set to the host.

The packet reconstruction unit may reconstruct the extracted traffic data feature set in the form of an IP packet according to a type length value (TLV) construction method. The traffic data feature set may include at least one of a flow identifier, 5-tuple information, general packet radio service (GPRS) tunnelling protocol (GTP) information, statistical information for each flow, and TCP connection information.

The host may use the received data feature set to detect a deep learning-based anomaly and prevent an intrusion.

A method of constructing a data feature set using an MEC device in an MEC environment according to another embodiment may include receiving, from a switch, an input packet copied from a front end of an input packet; extracting a data feature set of mobile network traffic from the received copied packet; and transmitting the extracted traffic data feature set to a host.

The extracting of the data feature set may include calculating a hash value for received copied packet; generating the traffic data feature set by extracting metadata from the copied packet and calculating a count for each packet type; and generating a data feature set for a TCP connection by counting the number of connections.

The transmitting of the extracted traffic data feature set to the host may include reconstructing the extracted traffic data feature set in the form of an IP packet according to a TLV construction method, and then transmitting the reconstructed data feature set to the host.

According to a mobile edge computing system and a method of constructing a data feature set using the same of the present disclosure, in an MEC system on a mobile edge network, a switch copies only a front end of an input packet and transmits the copied front end to an MEC device, the MEC device extracts a traffic data feature set in hardware and then transmits the extracted traffic data feature set to a host, and the host uses the traffic data feature set to perform security services including detection of a network anomaly using deep learning.

As a method of extracting a traffic data feature set, an offline method or a method of capturing traffic and processing the captured traffic in software causes a delay and is inefficient. In contrast, in the method of the present disclosure, real-time processing is possible because the MEC device extracts the traffic data feature set in hardware. The traffic data feature set extracted from the MEC device can be effectively utilized for real-time deep learning analysis of the host.

Furthermore, an additional platform and costs were required to perform security services such as network anomaly detection in a mobile edge network environment, but integrated construction of the data feature set can be achieved within a single platform through the MEC system, thereby implementing the data feature set effectively, at low cost, and with high-performance.

Other features and aspects will be apparent from the following detailed description, the accompanying drawings, and the claims.

### BRIEF DESCRIPTION OF THE DRAWINGS

FIG. 1 is a diagram illustrating a configuration of a mobile network system according to an embodiment of the present disclosure.

FIG. 2 is a diagram illustrating a configuration of a mobile edge computing (MEC) device according to an embodiment of the present disclosure.

FIG. 3 is a diagram illustrating a packet front-end copying method of a switch according to an embodiment of the present disclosure.

FIG. 4 is a diagram illustrating a process of reconstructing a data feature set in the form of a type length value (TLV) from a front end copied packet according to an embodiment of the present disclosure.

FIG. 5 is a flowchart illustrating a method of constructing a data feature set according to an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Advantages and features of the present disclosure, and a method of achieving them will become apparent with reference to embodiments described below in detail, together with the accompanying drawings. However, the present disclosure is not limited to the embodiments described below, and may be implemented in various different forms. These embodiments are provided only to make the disclosure of the present disclosure complete and to fully inform the scope of the present invention to those skilled in the art, and the present disclosure is only defined by the scope of the claims. Like reference numerals refer to like elements throughout the specification.

In the description below, when it is determined that detailed descriptions of related well-known functions unnecessarily obscure the gist of the present disclosure, detailed descriptions thereof will be omitted. Some terms described below are defined by considering functions in the present disclosure and meanings may vary depending on, for example, a user or operator's intentions or customs. Therefore, the meanings of terms should be interpreted based on the scope throughout this specification.

Hereinafter, embodiments of the present disclosure will be described in detail with reference to the accompanying drawings. However, the embodiments of the present disclosure illustrated below may be modified in various other forms, and the scope of the present disclosure is not limited to the embodiments described below. The embodiments of the present disclosure are provided to more completely explain the present disclosure to those of ordinary skill in the art to which the present disclosure pertains.

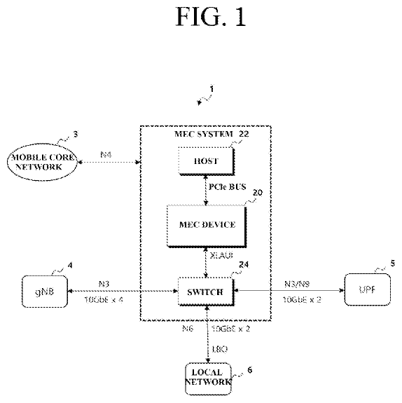

FIG. 1 is a diagram illustrating a configuration of a mobile network system according to an embodiment of the present disclosure.

Referring to FIG. 1, a mobile network system 1 includes a mobile edge computing (MEC) system 2, a mobile core network 3, a base station (gNodeB: gNB, hereinafter referred to as “gNB”) 4, a user plane function (UPF, hereinafter referred to as “UPF”) 5, and a local network 6.

The MEC system 2 includes an MEC device 20, a host 22, and a switch 24.

The MEC system 2 is connected to the mobile core network 3 through N4, connected to the gNB 4 through N3, and connected to the UPF 5 through N3 or N9 to be operated. In addition, an Ethernet link is connected to the Internet or the internal local network 6 through N6 to perform local break out (LBO, hereinafter referred to as “LBO”). The N4, N3, N9, and N6 are reference interfaces displayed in a reference model.

The MEC system 2 relieves congestion of the mobile core network 3 and creates a new local service by providing cloud computing capability and an IT service environment in the mobile network edge. The MEC system 2 according to the embodiment performs high-speed processing on the LBO independently of the mobile core network. The LBO a service connection path that enables a mobile network operator (MNO) to provide a data ordering function directly from a mobile network to users. Through the LBO, users can receive data services directly from the visited mobile network. The LBO service refers to a service in which user data is forwarded directly through the LBO path without passing through a core network.

The MEC device 20 according to the embodiment processes the LBO at a high-speed and low delay with respect to a general packet radio service (GPRS, hereinafter referred to as “GPRS”) tunneling protocol user plane (GPRS tunneling protocol user plane: GTP-U, hereinafter referred to as “GTP-U”) packet independently of the mobile core network 3. The GTP-U packet is an Internet protocol (IP)-based communication protocol packet used to forward a GPRS within a mobile network.

In order for the host 22 to perform network anomaly detection based on deep learning in real-time, the MEC device 20 extracts a data feature set from mobile network traffic and transmits the extracted data feature set to the host 22. When the MEC device extracts the data feature set in real-time and transmits the extracted data feature set to the host 22, the host 22 uses the data feature set received from the MEC device 20 to perform anomaly detection for a network infringement response in a deep learning method in real-time.

The host 22 performs statistical processing, control, and security services that block the intrusion of harmful traffic such as malicious code and hacking into the internal network, through metadata received from the MEC device 20. The host 22 may be an intrusion protection system (IPS) server and may perform a function through a central processing unit (CPU).

The host 22 according to the embodiment detects an anomaly in the network through deep learning analysis. The host 22 may perform deep learning analysis, particularly, anomaly detection for a network infringement response in real-time with reference to the traffic data feature set received from the MEC device 20. Compared to a method in which the host 22 receives raw packets to perform deep learning analysis, by receiving and using the traffic data feature set extracted using the hardware-based MEC device 20, the host 22 may perform deep learning analysis at a higher speed.

In order for the MEC device 20 to extract the data feature set of the mobile network traffic at the high-speed, the switch 24 may copy a predetermined size (e.g., an 80-byte sized front end) of an input packet and transmit the copied front end to the MEC device 20.

The switch 24 may perform encapsulation and decapsulation of the GTP-U packet. Encapsulation encapsulates an IP packet into a GTP-U packet, and decapsulation decapsulates the GTP-U packet into the IP packet.

In order to perform encapsulation and decapsulation of a high-performance GTP-U packet, the switch 24 may include a plurality of multi-core processors, have a media access control (MAC) function for 10G and 40G Ethernet interfaces, and may include a memory interface and a Peripheral Component Interconnect Express (PCIe) interface for inter processor communication (IPC) with the host 22.

The switch 24 copies a front end packet having a predetermined length from the input packet for high-speed data feature set extraction of the MEC device 20 and transmits the copied packet to the MEC device 20. Here, the predetermined length may be set by a user input or may be set to a default value (e.g., 80 bytes) in consideration of the structure of the GTP-U packet or IP packet. The reason for copying and transmitting only the front end of the packet is that performance and speed decrease when the full packet is copied and transmitted and effective data feature set extraction is possible even by analyzing only the front end.

The switch 24 forwards the encapsulated or decapsulated packet to the interface N3 or N6, and transmits the front end copied packet to the MEC device 20 so that the data feature set is extracted. An interface between the MEC device 20 and the switch 24 is constructed using a 40 gigabit attachment unit interface (XLAUI) so that 40 Gbps traffic can be transmitted.

The MEC device 20 receives the front end copied packet from the switch 24 and analyzes the copied packet to extract the data feature set of the mobile network traffic. Next, the extracted data feature set is transmitted to the host 22 through a PCIe bus.

The host 22 detects a deep learning-based network anomaly using the data feature set extracted from the MEC device 20. Anomaly detection may be performed in an application service software module of the host 22. Such application service software may be a deep learning-based network anomaly detection and intrusion prevention application service program.

The MEC device 20 may be a field programmable gate array (FPGA)-based hardware module. For example, the MEC device 20 is implemented in hardware to achieve GTP packet processing of 40 Gbps or more and a packet delay of 100 μsec or less. Since the software implementation method depends on the CPU, the software implementation method is greatly affected by the CPU processing performance, but a hardware implementation method can be CPU-free.

The MEC device 20 may include a memory for high-speed data processing, for example, a ternary content-addressable memory (TCAM, hereinafter referred to as “TCAM”). The TCAM may use a general commercial chip.

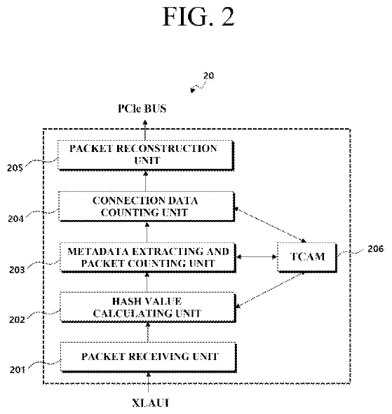

FIG. 2 is a diagram illustrating a configuration of an MEC device according to an embodiment of the present disclosure.

Referring to FIGS. 1 and 2, the MEC device 20 includes a packet receiving unit 201, a processor, and a TCAM 206. The processor includes a hash value calculating unit 202, a metadata extracting and packet counting unit 203, a connection data counting unit 204, and a packet reconstruction unit 205.

The packet receiving unit 201 receives a front end copied packet (e.g., 80 bytes) from the switch 24 through an XLAUI interface.

The hash value calculating unit 202 calculates a hash value from a predetermined hash field for the copied packet received through the packet receiving unit 201. This hash value may be used as an identifier (ID) for recognizing a connection or flow of a GTP-U packet or an IP packet, and may be stored in the TCAM 206 and used as a search key.

The metadata extracting and packet counting unit 203 extracts metadata from the received packet, calculates the number of received bytes of the packet, the total number of packets, the number of connections, the number of connection bytes, the connection time, and a count for each packet type per unit time for the purpose of generating the data feature set, stores the calculated information in the connected TCAM 206 as the hash value, and periodically generates the traffic data set. The packet types are classified based on an IP protocol type. The metadata of the packet is a 5-tuple of an IP packet, a termination endpoint identification (TEID) of a GTP-U packet, and GTP packet types.

The connection data counting unit 204 generates a data feature set for a transmission control protocol (TCP) connection. The TCP connection starts with a Sync packet and ends with a Fin packet in a TCP protocol. The connection data counting unit 204 detects a TCP connection and extracts TCP connection information including the number of connections per unit time, the total number of bytes per connection, and a statistical value of time. In addition, when the TCP connection is abnormally terminated, for example, when the TCP connection is terminated without a Fin packet, the connection data counting unit 204 sets a timeout time, and determines that the TCP connection ends when there is no Fin packet within a predetermined timeout time. The timeout time may be set by a user operation, but may be set to a default value (e.g., 300 seconds). Since the TCP connection is often terminated in an abnormal state as well as in a normal protocol handshake, the connection data counting unit 204 may also extract statistical data of each abnormal connection.

The packet reconstruction unit 205 reconstructs the traffic data feature set extracted through the metadata extracting and packet counting unit 203 and the connection data counting unit 204 in the form of an IP packet, and then transmits the reconstructed data feature set to the host 22 through the PCIe bus. A method of utilizing the data feature set transmitted to the host 22 is not specified in the present disclosure.

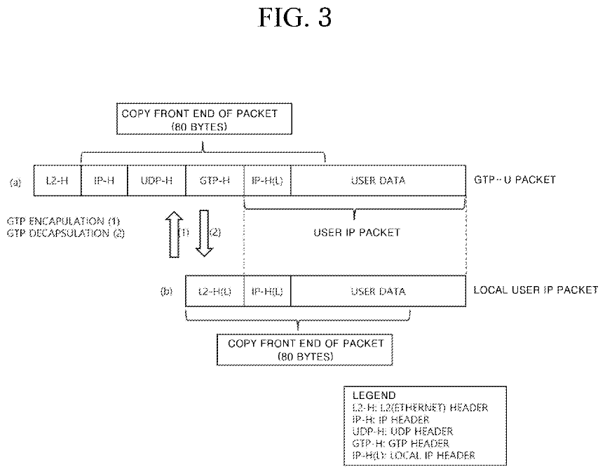

FIG. 3 is a diagram illustrating a packet front-end copying method of a switch according to an embodiment of the present disclosure.

Referring to FIGS. 1 and 3, the switch 24 copies only a portion of a front end of a packet to extract a mobile network traffic data feature set in the MEC device 20.

There are two types of the input packet, wherein type (a) is a packet input from the gNB 4 through the interface N3, which is a packet with a GTP-U structure, and type (b) is a packet input from the local network 6 through the interface N6, which is a type of an IP packet. Both types of the packet are copied from a front end of a predetermined size (e.g., 80 bytes). When the packet size is smaller than the predetermined size, as much as the packet size is copied. The size of the GTP-U packet input through the interface N3 is generally large, and in the case of a connection for security such as a Secure SHell (SSH), in most cases, the size of the corresponding packet is greater than or equal to 1,000 bytes. Accordingly, the method in which the switch 24 copies only the front end of the packet has a significant effect in improving performance.

The switch 24 transmits the copied packet to the MEC device 20 through an XLAUI interface. The XLAUI interface is a standard interface that supports up to 40 Gbps, and is a transmission link with a sufficient margin to transmit the copied packet.

Since the copying of the packet is applied only to an input packet and not to an output packet, the copying of the packet is not duplicated.

The traffic data feature set may include at least one of a flow identifier, 5-tuple information, GTP information, statistical information for each flow, and TCP connection information. It is assumed that flows having the same hash identifier are the same flow, and in the case of TCP packets, it is assumed that connections having the same hash identifier are the same connection. The flow identifier is divided by a hash value generated by combining a 5-tuple and a specified field. The 5-tuple information includes a source IP address, a destination IP address, a source port, a destination port, and protocol information. The GTP information includes TEID and GTP packet type information. The statistical information for each flow includes the number of received bytes and flow duration information. The TCP information includes statistics for each TCP packet type and TCP information per unit time. The TCP connection information includes the number of received bytes, the connection duration, and the number of connection errors.

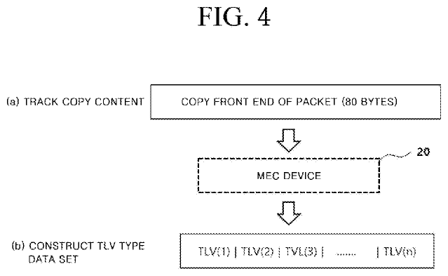

FIG. 4 is a diagram illustrating a process of reconstructing a data feature set in the form of a type length value (TLV) from a front end copied packet according to an embodiment of the present disclosure.

Referring to FIGS. 1 and 4, the MEC device 20 reconstructs the extracted data feature set into an IP packet and transmits the reconstructed data feature set to the host 22. A method of reconstructing a data feature set into an IP packet may use a TLV construction method. A detailed TLV construction method is as follows.
Type (1 byte): 1 byte information, a unique value according to the type of data feature set.
Length (1 byte): length (n) of value
Value (n bytes): length of value corresponding to specific type

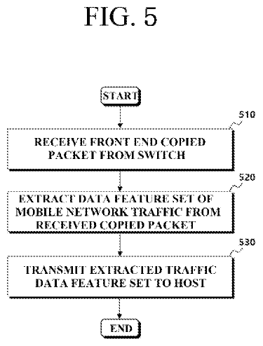

FIG. 5 is a flowchart illustrating a method of constructing a data feature set according to an embodiment of the present disclosure.

Referring to FIGS. 1 and 5, in operation 510, the MEC device 20 receives, from the switch 24, a packet copied from a front end of an input packet.

Next, in operation 520, the MEC device 20 extracts a data feature set of mobile network traffic from the received copied packet. In operation 520 of extracting the data feature set, the MEC device 20 may calculate a hash value for the received copied packet, may extract metadata from the copied packet, may calculate a count for each packet type to generate a traffic data feature set, and may generate a data feature set for a TCP connection by counting the number of connections. The traffic data feature set may include at least one of a flow identifier, 5-tuple information, GTP information, statistical information for each flow, and TCP connection information.

Next, in operation 530, the MEC device 20 transmits the extracted traffic data feature set to the host 22. In operation 530 of transmitting the traffic data feature set to the host, the MEC device 20 may reconstruct the extracted traffic data feature set in the form of an IP packet according to a TLV construction method and may then transmit the reconstructed traffic data feature set to the host 22.

As described above with reference to FIGS. 1 and 5, in the MEC system 2, in the mobile edge network, the switch 24 copies only the front end of the input packet and transmits the copied packet to the MEC device 20, the MEC device 20 extracts the traffic data feature set in hardware and transmits the extracted data feature set to the host 22, and the host 22 uses the traffic data feature set to perform security services including network anomaly detection using deep learning.

As a method of extracting a traffic data set, an offline method or a method of capturing traffic and processing the captured traffic in software causes a delay and is inefficient. In contrast, in the method of the present disclosure, real-time processing is possible because the MEC device 20 extracts a traffic data feature set in hardware. The traffic data feature set extracted from the MEC device 20 can be effectively utilized for real-time deep learning analysis of the host 22.

Furthermore, an additional platform and costs were required to perform security services such as network anomaly detection in a mobile edge network environment, but integrated construction of the data feature set can be achieved within a single platform through the MEC system 2, thereby implementing the data feature set effectively, at low cost, and with high-performance.

So far, the present disclosure has been described with reference to embodiments thereof. Those of ordinary skill in the art to which the present disclosure pertains will understand that the present disclosure can be implemented in a modified form without departing from the essential characteristics of the present disclosure. Therefore, the disclosed embodiments are to be considered in an illustrative rather than a restrictive sense. The scope of the present disclosure is indicated in the claims rather than the above description, and all differences in the scope equivalent thereto should be construed as being included in the present disclosure.

What is claimed is:

1. A mobile edge computing system that is a mobile network system in a mobile edge computing (MEC) environment, the mobile edge computing system comprising:
a switch configured to copy a front end of an input packet;
an MEC device configured to receive a front end copied packet from the switch to extract a data feature set of mobile network traffic; and
a host configured to receive a traffic data feature set extracted from the MEC device to perform a security service.

2. The mobile edge computing system of claim 1, wherein the switch is configured to copy the front end of to the input packet with a predetermined size and to copy the front end by as much as a size of the packet when the size of the input packet is smaller than the predetermined size, and the predetermined size is set by a user operation or set to a default value.

3. The mobile edge computing system of claim 1, wherein the MEC device is a hardware module based on a field programmable gate array (FPGA).

4. The mobile edge computing system of claim 1, wherein the MEC device includes:
a packet receiving unit configured to receive the front end copied packet from the switch; and
a hash value calculating unit configured to calculate a hash value for the copied packet received through the packet receiving unit,
wherein the hash value is used as an identifier for recognizing a connection or flow of a packet.

5. The mobile edge computing system of claim 1, wherein the MEC device includes:
a metadata extracting and packet counting unit configured to generate the traffic data feature set by extracting metadata from the copied packet and calculating a count for each packet type; and
a connection data counting unit configured to generate a data feature set for a transmission control protocol (TCP) connection by counting the number of connections.

6. The mobile edge computing system of claim 5, wherein, when the connection is abnormally terminated, the connection data counting unit determines the termination of the connection by setting a timeout time and extracts statistical data of the abnormal connection,
wherein the timeout time is set by a user operation or set to a default value.

7. The mobile edge computing system of claim 1, wherein the MEC device includes a packet reconstruction unit configured to reconstruct the extracted traffic data feature set in a form of an Internet protocol (IP) packet and then transmit the reconstructed traffic data feature set to the host.

8. The mobile edge computing system of claim 7, wherein the packet reconstruction unit reconstructs the traffic data feature set in the form of an IP packet according to a type length value (TLV) construction method.

9. The mobile edge computing system of claim 1, wherein the traffic data feature set includes at least one of a flow identifier, 5-tuple information, general packet radio service (GPRS) tunnelling protocol (GTP) information, statistical information for each flow, and TCP connection information.

10. The mobile edge computing system of claim 1, wherein the host uses the received data feature set to detect a deep learning-based anomaly and prevent an intrusion.

11. A method of constructing a data feature set using a mobile edge computing (MEC) device in an MEC environment, the method comprising:
receiving, from a switch, an input packet copied from a front end of an input packet;
extracting a data feature set of mobile network traffic from the received copied packet; and
transmitting the extracted traffic data feature set to a host.

12. The method of claim 11, wherein the extracting of the data feature set includes:
calculating a hash value for the received copied packet;
generating the traffic data feature set by extracting metadata from the copied packet and calculating a count for each packet type; and
generating a data feature set for a transmission control protocol (TCP) connection by counting the number of connections.

13. The method of claim 11, wherein the transmitting of the traffic data feature set to the host includes reconstructing the extracted traffic data feature set in a form of an Internet protocol (IP) packet according to a type length value (TLV) construction method, and then transmitting the reconstructed data feature set to the host.
